(19) United States
(12) Patent Application Publication
(10) Pub. No.: US 2016/0312697 A1
(43) Pub. Date: Oct. 27, 2016

(54) Gasification Combined Generation System Through Coal and Industrial Waste Water

(71) Applicant: Korea Institute of Energy Research, Daejeon (KR)

(72) Inventors: Sang-Jun Yoon, Sejong-si (KR); Ho-won Ra, Daejeon (KR); Jae-goo Lee, Daejeon (KR); Myung-won Seo, Daejeon (KR); Sang-goo Jeon, Daejeon (KR); Deog-keun Kim, Daejeon (KR)

(73) Assignee: Korea Institute of Energy Research, Daejeon (KR)

(21) Appl. No.: 14/815,065

(22) Filed: Jul. 31, 2015

(30) Foreign Application Priority Data
Apr. 27, 2015 (KR) 10-2015-0059242

(51) Int. Cl. F02C 3/28; H01M 8/0612; C10J 3/48; C10J 3/52; F01K 23/06; C10J 3/72

(52) U.S. Cl. CPC F02C 3/28; F01K 23/067; C10J 3/72; C10J 3/485; C10J 3/526; C10J 3/723; H01M 8/0612; C10J 2300/1671; C10J 2300/1606; C10J 2300/093; C10J 2300/0903; C10J 2300/1693; C10J 2300/1646; C10J 2300/165; C10J 2300/1603; C10J 2300/0946; C10J 2200/15; C10J 2300/0906; C10J 2300/0956; C10J 2300/0983

(57) ABSTRACT

The present invention relates to a gasification combined generation system including: a slurry mixer adapted to receive the coal and industrial waste water thereto and mix them to make a uniform-quality slurry; a slurry storage adapted to receive the uniform-quality slurry from the slurry mixer and store the slurry therein; a slurry pump adapted to convey the slurry from the slurry storage; a slurry gasifier adapted to gasify the slurry with at least one of oxygen and air as an oxidizer and produce gas and slag from the gasified slurry; a gas analyzer adapted to analyze the components of the gas discharged from the slurry gasifier; a gas purifier adapted to purify the discharged gas; a generator adapted to utilize the purified gas as a fuel to generate electricity; and a slag discharger adapted to discharge the slag therefrom.

### CROSS-REFERENCE TO RELATED APPLICATIONS

The present application claims priority to Korean Patent Application No. 10-2015-0059242, filed Apr. 27, 2015, the entirety of which is incorporated herein by reference.

### BACKGROUND OF THE INVENTION

1. Field of the Invention

The present invention relates to a gasification combined generation system through coal and industrial waste water that gasifies the coal and industrial waste water adequate for a distributed power system to generate electricity, and more particularly, to a gasification combined generation system through coal and industrial waste water that conducts energy production as well as waste water treatment through a slurry as a mixture of the coal with the industrial waste water, thus producing inflammable synthesis gas from the slurry through a 1 ton/day wet-feeding entrained flow gasifier, performing power generation through a gas engine, and achieving heat application to industrial fields through waste heat recovery.

2. Background of the Related Art

The most important thing for people in the future is to stably ensure energy sources as well as food resources. Above all, renewable energy should be developed and used for the power generation in the future, but when considering current technology level, a great quantity of energy is still dependent upon fossil fuels.

Among the fossil fuels, coal occupies the greatest quantity, and since the coal is in a solid state, it is hard to handle it. Further, the coal is more difficult in adjustment of the combustion than oil or gas, and the coal causes environmental pollution, thus being restricted in the application range thereof.

In case of domestic fuel consumption, however, the coal occupies 28% of the total energy consumption quantity and necessarily used in power generation and iron manufacturing fields as well as various industrial fields. Accordingly, since the coal still has a high value as an energy source, there is a need for a new plan with which coal is utilized as a future industrial energy source in a clean and efficient manner.

If the coal is used as generation fuel, it is considered that environmental actions and heat efficiency improvement should be prepared. It has been already proved that 300 MWe large power plants are environment-friendly and high in efficiency. Further, energy demand has been drastically increased in development countries like Indonesia, and in most cases, a first energy source becomes coal.

Methods for applying coal to power generation are classified into a method for producing steam with the heat obtained by directing burning the coal and a method for producing synthesis gas from coal to produce electricity with the produced synthesis gas. The gasification of the coal is developed to a coal conversion technology that uses a smaller quantity of oxygen than the complete combustion of the coal and produces synthesis gas having main components of CO and H₂ through the reaction with oxygen and water vapor under high temperature and pressurization conditions, and further, the gasification of the coal becomes a very important technology in a coal chemical industry.

Coal gasification combined power generation using the coal gasification is carried out by converting coal into gas under a high temperature condition, burning the gas in an internal combustion engine, a gas turbine or a fuel cell, and producing electric power therefrom.

In case of existing coal gasification technologies, however, large-scale integrated gasification combined cycle (IGCC), coal to liquids (CTL), synthetic natural gas (SNG) have been generally developed, and also, developments for an oxygen blown gasification technology using a high cost oxygen separator have been focused. Further, coal is generally supplied in a relatively complicated dry feeding way causing a high cost.

On the other hand, industrial waste water is produced from a variety of middle or small-sized industries, partially treated or reused, or is entrusted in treatment to a third person, thus making costs for energy, facility and entrustment treatment undesirably consumed. Accordingly, the costs are associated with the manufacturing costs of the industrial products, thus giving bad influences on economical aspects, and if a portion of the waste water is discharged in the state of being not perfectly treated, many problems in environmental aspects occur. Accordingly, there is a need for the development of a distributed power system capable of treating harmful industrial waste water, without having any additional cost, providing a low facility investment cost, and having a simple operation.

### SUMMARY OF THE INVENTION

Accordingly, the present invention has been made in view of the above-mentioned problems occurring in the prior art, and it is an object of the present invention to provide a gasification combined generation system through coal and industrial waste water that conducts energy production as well as waste water treatment through a slurry as a mixture of the coal with the industrial waste water, thus producing inflammable synthesis gas from the slurry through a 1 ton/day wet-feeding entrained flow gasifier, performing power generation through a gas engine, and achieving heat application to industrial fields through waste heat recovery.

It is another object of the present invention to provide a distributed power system to which a gasification combined generation system through coal and industrial waste water, in which a wet-feeding entrained flow gasification technology using air as a gasification agent is adopted, is applied, thus treating harmful industrial waste water, without having any additional cost, providing a low facility investment cost, and having a simple operation.

To accomplish the above-mentioned objects, according to the present invention, there is provided a gasification combined generation system through coal and industrial waste water, the system including: a slurry mixer adapted to receive the coal and industrial waste water thereto and mix them to make a uniform-quality slurry; a slurry storage adapted to receive the uniform-quality slurry from the slurry mixer and store the slurry therein; a slurry pump adapted to convey the slurry from the slurry storage; a slurry gasifier adapted to gasify the slurry with at least one of oxygen and air as an oxidizer and produce gas and slag from the gasified slurry; a gas analyzer adapted to analyze the components of the gas discharged from the slurry gasifier; a gas purifier adapted to purify the discharged gas; a generator adapted to utilize the purified gas as a fuel to generate electricity; and a slag discharger adapted to discharge the slag therefrom.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a diagram showing the whole configuration of a gasification combined generation system through coal and industrial waste water according to the present invention.

### DETAILED DESCRIPTION OF THE PREFERRED EMBODIMENTS

Hereinafter, an explanation on a gasification combined generation system through coal and industrial waste water according to the present invention will be in detail given with reference to the attached drawing.

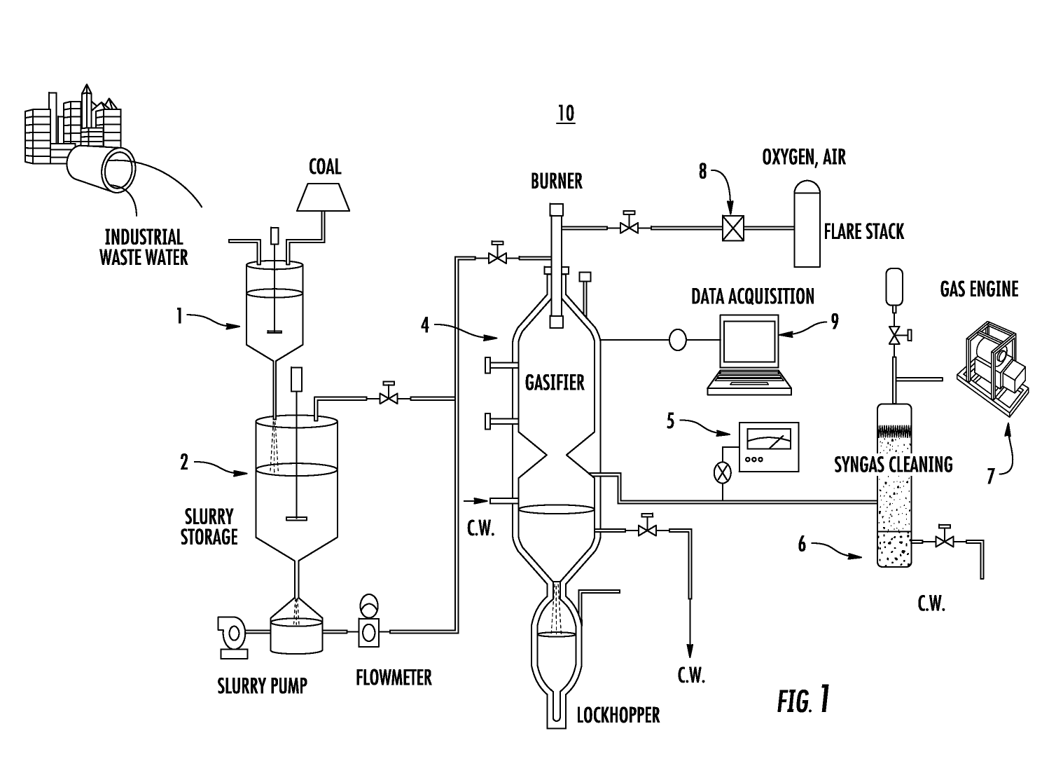

The present invention relates to a gasification combined generation system 10 that gasifies coal and industrial waste water adequate for a distributed power system to produce electricity, and as shown in FIG. 1, the gasification combined generation system 10 includes: a slurry mixer 1 adapted to receive the coal and industrial waste water thereto and mix them to make a uniform-quality slurry; a slurry storage 2 adapted to receive the uniform-quality slurry from the slurry mixer 1 and store the slurry therein; a slurry pump 3 adapted to convey the slurry from the slurry storage 2; a slurry gasifier 4 adapted to gasify the slurry with at least one of oxygen and air as an oxidizer and produce gas and slag from the gasified slurry; a gas analyzer 5 adapted to analyze the components of the gas discharged from the slurry gasifier 4; a gas purifier 6 adapted to purify the discharged gas; a generator 7 adapted to utilize the purified gas as a fuel to generate electricity; and a slag discharger adapted to discharge the slag therefrom.

According to the present invention, further, the slurry gasifier 4 is a wet-feeding entrained flow gasifier that provides a low facility investment cost and uses air whose operation is simple as a gasification agent.

If the industrial waste water and the coal are mixed and fed as a slurry to the gasifier operating at 1100° C. or more, energy is produced through the gasification of the coal, and at the same time, the heavy metals in the industrial waste water are stabilized in coal ash slag and discharged, while VOCs is being burnt, as shown in Table 1, so that perfect treatment for the industrial waste water can be achieved, without having any additional treatment cost.

TABLE 1
(unit: mg/kg)

Sample
Arch Coal

| Element | Coal | Slag |
|---|---|---|
| Pb | N.D.* | 33.632 |
| Cu | N.D.* | 35.874 |
| A₅ | 0.782 | N.D.* |
| Hg | 0.782 | N.D.* |
| Cd | N.D.* | 1.495 |
| Cr⁶⁺ | N.D.* | N.D.* |
| CN | 10.551 | 15.695 |
| Cr | 11.33 | 16328.85 |
| Nl | 0.010 | 214.50 |
| Zn | 24.62 | N.D.* |
| Mn | 30.48 | 581.47 |
| Co | 1.954 | 59.79 |
| Ba | 161.78 | 3363.23 |
| Sr | 293.08 | 4742.90 |
| Zr | 3.126 | 5476.83 |

Sample

| | Leachate | |
|---|---|---|
| | of | |
| | Arch Coal | Regulation |
| Element | Slag | Limit** (mg/L) |
| Pb | 0.011 | 3 |
| Cu | N.D.* | 3 |
| A₅ | N.D.* | 1.5 |
| Hg | N.D.* | 0.005 |
| Cd | N.D.* | 0.3 |
| Cr⁶⁺ | N.D.* | 1.5 |
| CN | N.D.* | 1 |
| Cr | 0.044 | — |
| Nl | N.D.* | — |
| Zn | 0.011 | — |
| Mn | N.D.* | — |
| Co | N.D.* | — |
| Ba | 0.013 | — |
| Sr | 0.01 | — |
| Zr | N.D.* | — |

Further, the gas purifier 6 includes a cyclone, a dust filter, and an oil extractor. The gas purifier 6 serves to remove impurities like sulfur compounds and nitrogen compounds from the gas generated from the slurry gasifier 4 and to purify the gas. The gas purified through the gas purifier 6 is used as a fuel for the generator 7. The generator 7 is formed of at least one of an internal combustion engine, a gas engine, and a fuel cell. Desirably, the generator 7 is the gas engine.

Further, the gasification combined generation system 10 includes a controller 9.

Additionally, the gasification combined generation system 10 of the coal and industrial waste water includes a compressor 8 adapted to feed at least one of the oxygen and air. So as to achieve economical distributed gasification generation, gasification technology using air through the compressor 8, not through a high-priced oxygen blown manufacturing system, is necessarily required, so that the compressor 8 should be introduced in the gasification combined generation system 10.

So as to increase the uniform mixing between the coal and the industrial waste water and the efficiency of coal gasification, further, the gasification combined generation system 10 desirably includes a pulverizer for uniformly pulverizing the coal to a mean diameter of 100 um or less before the coal is mixed with the industrial waste water. In this case, the content of coal is in the range of 50 to 80 wt % of the slurry. If the content of coal is 50 wt % or less, the gasification efficiency becomes low, and contrarily, if the content of coal is 80 wt % or more, the viscosity of the slurry becomes increased to cause the conveying cost to be undesirably raised, thus resulting in the increment of the processing cost thereof.

So as to improve the dispersion of the slurry as the mixture of the coal and the industrial waste water, furthermore, a dispersing agent is additionally contained in the slurry. The dispersing agent is selected from the group consisting of: naphthalene sulfonic acid and sulfonate; petroleum sulfonic acid and sulfonate; lignin sulfonic acid and sulfonate; formaldehyde concentrates thereof; polyoxyethylene alkyl ether sulfuric ester and sulfate; polyoxyethylene alkylaryl ether sulfuric ester and sulfate; polyglycerol sulfate; and melamine resin sulfonic acid and sulfonate.

Further, the gasification combined generation system 10 through coal and industrial waste water according to the present invention is applicable to a distributed power system. A quantity of maximum domestic power consumption has been increased year by year, and accordingly, the crisis of blackout may be frequently confronted. As listed in Table 2, according to a second domestic energy plan revised in early 2015, distributed power systems are arranged and will be increased up to 15% by 2035, which is unlike a first plan. More than 50% of the whole quantity of domestic power consumption occurs in various industrial fields, and next, power consumption for general use and house use occurs. Accordingly, the gasification combined generation system 10 of the coal and industrial waste water according to the present invention feeds the coal/industrial waste water slurry to the slurry gasifier 4 as the wet-feeding entrained flow gasifier through the slurry pump 3, so that when compared with a dry-feeding entrained flow gasifier, the fuel feeding system is simpler, the facility cost is lower, the feeding cost of water for gasification is reduced through the use of the industrial waste water, and the industrial waste water is treated thermally. Therefore, the gasification combined generation system 10 according to the present invention is applicable to a distributed generation technology and is also environment-friendly.

TABLE 2

| Division | First Plan | Second Plan |
|---|---|---|
| Plan Period | 2008-2030 | 2014-2035 |
| Establishment | Established by | Open type process |
| Process | Government | structure (drafting |
| | (acceptance of | by civil governors) |
| | opinions after | |
| | draft plan) | |
| Supply and Demand | Supply-centered | Demand management type |
| Demand Management | Regulation | ICT + Market-based |
| Power Plant | Large-scale | Distributed generation |
| | centralized | system |
| | power plant | |
| Percentage of | 41% | 29% |
| Nuclear Power Plant | | |
| New and Renewable | 11% | 11% |
| Energy Supply | | |
| Others | | *Distributed generation |
| | | percentage (5→15%) |
| | | *energy voucher |
| | | introduction (′15) |

As set forth in the foregoing, the gasification combined generation system through coal and industrial waste water according to the present invention ensures a distributed air gasification technology from large size and oxygen blown gasification-centered gasification technologies, thus being expanded to various scales and fields.

Further, the gasification combined generation system through coal and industrial waste water according to the present invention makes use of wet-feeding gasification having a lower cost and easier operation than the existing dry-feeding fuel gasification, thus providing economical technology and performing environment-friendly treatment and discharge of various industrial waste water.

Moreover, the gasification combined generation system through coal and industrial waste water according to the present invention is applicable to industrial fields wherein waste water generated from industries producing and selling bucker C oil through the purification of petroleum and bio-oil waste is mixed and emulsified with a low quality of tar type residual and replacement oil to produce and use electricity therefrom.

The gasification combined generation system according to the present invention is in detail described with reference to the drawing, but the system may be produced in many different configurations, forms, and materials, with the understanding that the present disclosure is to be considered as an exemplification of the principles of the invention and the associated functional specifications for its construction and is not intended to limit the invention to the embodiment illustrated. Those skilled in the art will envision many other possible variations within the scope of the present invention.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention. Further, the present invention is applicable to sport shoes reducing knee adduction moments.

What is claimed is:

1. A gasification combined generation system through coal and industrial waste water, the system comprising:
a slurry mixer 1 adapted to receive the coal and industrial waste water thereto and mix them to make a uniform-quality slurry;
a slurry storage 2 adapted to receive the uniform-quality slurry from the slurry mixer 1 and store the slurry therein;
a slurry pump 3 adapted to convey the slurry from the slurry storage 2;
a slurry gasifier 4 adapted to gasify the slurry with at least one of oxygen and air as an oxidizer and produce gas and slag from the gasified slurry;
a gas analyzer 5 adapted to analyze the components of the gas discharged from the slurry gasifier 4;
a gas refinery 6 adapted to purify the discharged gas;
a generator 7 adapted to utilize the purified gas as a fuel to generate electricity; and
a slag discharger adapted to discharge the slag therefrom.

2. The gasification combined generation system according to claim 1, wherein the slurry gasifier 4 is a entrained flow coal water slurry gasifier.

3. The gasification combined generation system according to claim 1, wherein the gas purifier 6 comprises a cyclone, a dust filter, and an oil extractor.

4. The gasification combined generation system according to claim 1, wherein the generator 7 is formed of at least one of an internal combustion engine, a gas engine, and a fuel cell.

5. The gasification combined generation system according to claim 1, further comprising a controller 9.

6. The gasification combined generation system according to claim 1, further comprising a compressor 8 adapted to feed at least one of oxygen and air.

7. The gasification combined generation system according to claim 1, further comprising a pulverizer for uniformly pulverizing the coal to a mean diameter of 100 um or less before the coal is mixed with the industrial waste water.

8. The gasification combined generation system according to claim 7, wherein the content of coal is in the range of 50 to 80 wt % of the slurry.

9. The gasification combined generation system according to claim 8, wherein a dispersing agent is additionally contained in the slurry.

10. The gasification combined generation system according to claim 9, wherein the dispersing agent is selected from the group consisting of: naphthalene sulfonic acid and sulfonate; petroleum sulfonic acid and sulfonate; lignin sulfonic acid and sulfonate; formaldehyde concentrates thereof; polyoxyethylene alkyl ether sulfuric ester and sulfate; polyoxyethylene alkylaryl ether sulfuric ester and sulfate; polyglycerol sulfate; and melamine resin sulfonic acid and sulfonate.

11. A distributed power system using a gasification combined generation system according to claim 1.
